(19) United States
(12) Patent Application Publication
(10) Pub. No.: US 2020/0293258 A1
(43) Pub. Date: Sep. 17, 2020

(54) LAYOUT IDENTIFICATION METHOD FOR DISPLAY WALL, AND ELECTRONIC DEVICE USING THE SAME

(71) Applicant: Wistron Corporation, New Taipei City (TW)

(72) Inventor: Chia-Ching Lin, New Taipei City (TW)

(73) Assignee: Wistron Corporation, New Taipei City (TW)

(21) Appl. No.: 16/430,421

(22) Filed: Jun. 4, 2019

(30) Foreign Application Priority Data
Mar. 12, 2019 (TW) 108108168

(51) Int. Cl. G06F 3/14; G06F 3/147; G06K 9/46

(52) U.S. Cl. CPC G06F 3/1446; G06K 9/46; G06F 3/147

(57) ABSTRACT

A layout identification method for a display wall is provided, where the display wall is formed by stitching a plurality of displays according to an actual layout. The layout identification method includes following steps: displaying a preset image respectively through a signal by the displays of the display wall; capturing an image of the actual layout of the display wall through an image capturing element to obtain a display wall image of the display wall; identifying the display wall image according to an image analysis on the preset images, so as to obtain a virtual layout of the displays corresponding to the actual layout. An electronic device using the method is also provided.

### CROSS-REFERENCE TO RELATED APPLICATION

This application claims the priority benefit of Taiwan application serial no. 108108168, filed on Mar. 12, 2019. The entirety of the above-mentioned patent application is hereby incorporated by reference herein and made a part of this specification.

### TECHNICAL FIELD

The disclosure relates to an identification technology; more specifically, the disclosure relates to a layout identification method for a display wall formed by stitching a plurality of displays and an electronic device and a display system using the method.

### DESCRIPTION OF RELATED ART

A display wall (commonly referred to as a TV wall) is a large display screen wall formed by stitching displays; according to the way to arrange the displays, a control host of the display wall can control the displays to respectively display divided parts of an image, and the divided parts are combined to create a complete large image. In general, conventional displays having the same dimension are mostly stitched in a horizontal or vertical direction on a display wall without overlapping each other. However, in order to comply with the requirements for a more vivid and aesthetic design or special style, it is now common for manufacturers to stitching and assembly a plurality of displays of different sizes or/and at different tilt angles. Under certain circumstances and given some requirements, the arrangement or orientation of the displays on the display wall may be changed, the number of displays may be increased or decreased, or the displays may be replaced, thereby resulting in different layouts. Therefore, as long as the layout of the displays changes, users are bound to do re-measurement and calculation as well as input the new layout to the control host, so that the control host can correctly and collectively use these displays to display large images.

Manual measurement and calculation of the display layout of the displays is however time-consuming, labor-intensive, and inaccurate; moreover, if the display wall is at a high place or at another inaccessible position, the measurement and the calculation become less feasible.

### SUMMARY

In view of the above, one or more embodiments of the disclosure provide a layout identification method of a display wall and an electronic device and a display system using the method, so as to accurately obtain a layout of the display wall with ease and inform an image management device of the display wall of the obtained layout.

In an embodiment of the disclosure, a layout identification method of a display wall applicable to an electronic device is provided, wherein the display wall is formed by stitching a plurality of displays to establish an actual layout according to a preset layout. The layout identification method includes following steps: displaying a preset image respectively through a signal by the displays of the display wall; capturing an image of the actual layout of the display wall through an image capturing element to obtain a display wall image of the display wall; identifying the display wall image according to an image analysis on the preset images, so as to obtain a virtual layout of the displays corresponding to the actual layout.

In an embodiment of the disclosure, an electronic device which can be used together with a display wall is provided, wherein the display wall is formed by stitching a plurality of displays to establish an actual layout according to a preset layout. The electronic device includes a communication module, an image capturing element, and a processor. The communication module is capable of electrically communicating with the displays of the display wall. The image capturing element is configured to capture an image of the actual layout of the display wall to obtain a display wall image of the display wall. The processor is electrically coupled to the communication module and the image capturing element and configured to: instruct the plurality of displays respectively to display a preset image by the plurality of displays through the communication module and identify the display wall image according to an image analysis on the preset images to obtain a virtual layout of the plurality of displays corresponding to the actual layout.

To make the above features and advantages provided in one or more of the embodiments of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles described herein.

FIG. 1 is a schematic view of a display system according to an embodiment of the disclosure.

FIG. 2 is a block view of an electronic device according to an embodiment of the disclosure.

FIG. 3 is a flow chart of a layout identification method according to an embodiment of the disclosure.

FIG. 4 is a flow chart of a display method according to an embodiment of the disclosure.

FIG. 5 is a schematic view of a preset pattern according to an embodiment of the disclosure.

FIG. 6A to FIG. 6G schematically illustrate image identification according to an embodiment of the disclosure.

FIG. 7 is a schematic view of a virtual layout according to an embodiment of the disclosure.

FIG. 8 is a schematic view of a display image according to an embodiment of the disclosure.

### DESCRIPTION OF THE EMBODIMENTS

Some embodiments are provided in detail below with reference to the accompanying drawings. When the same reference numbers appear in different figures, they will be regarded as indicating the same or similar components. These embodiments are only part and are not all embodiments of the disclosure. More particularly, these embodiments are examples of a method, a device, and a system provided in the claims of this disclosure.

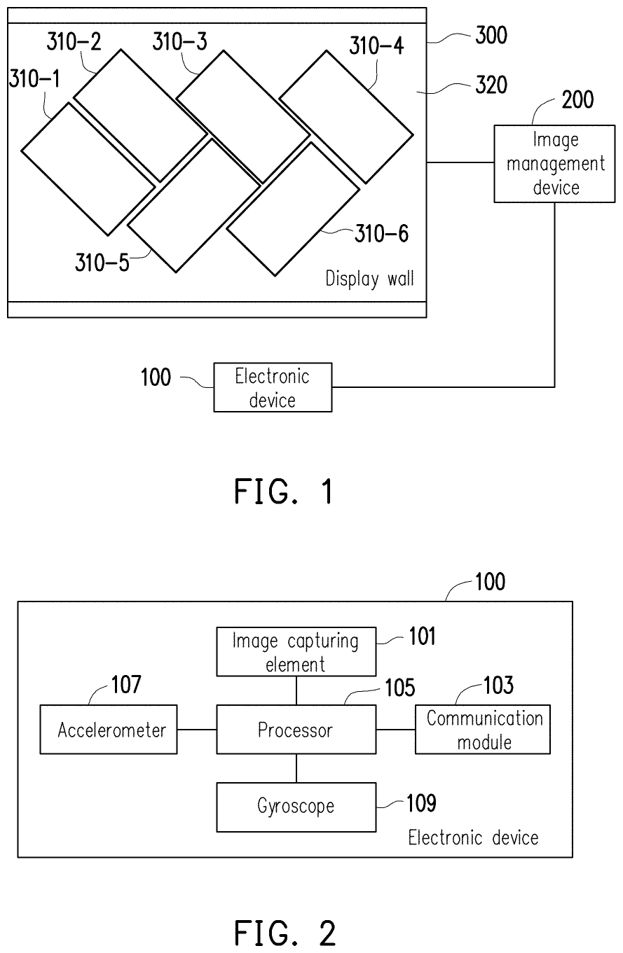

FIG. 1 is a schematic view of a display system according to an embodiment of the disclosure.

With reference to FIG. 1, the display system provided in the embodiment includes an electronic device 100, an image management device 200, and a display wall 300.

In the embodiment, the display wall 300 includes displays 310-1 to 310-6 fixed to a wall surface 320 according to a specific layout, and the actual number of the displays and the layout on the display wall 300 are not limited in the disclosure. Note that the so-called display in this disclosure may include any type of display having display capabilities, such as a TV screen, a computer screen, a projection screen, a cell phone screen, and so on, and the so-called display wall refers to an assembly of these displays stitched and fixed to the wall surface 320.

In the embodiment, the image management device 200 is electrically coupled to the displays 310-1 to 310-6 on the display wall 300 through a cable or in a wireless manner; the layout of the displays 310-1 to 310-6 on the display wall 300 can be set, and the divided images displayed on each of the displays 310-1 to 310-6 can be arranged according to the set layout, so as to collectively display the complete large display image through the displays 310-1 to 310-6. For instance, the image management device 200 may be a personal computer (PC), a notebook computer, a tablet PC, a server, a smart phone, and so forth, which should not be construed as a limitation in the disclosure.

In the embodiment, the electronic device 100 is electrically coupled to the displays 310-1 to 310-6 and the image management device 200 through a cable or in a wireless manner. Note that the electronic device 100 is capable of taking pictures and doing calculations and thus can be applied to capture a display wall image of the display wall 300 and calculate and simulate a virtual layout of the displays 310-1 to 310-6 corresponding to actual layout according to the display wall image. Besides, the electronic device 100 also transmits the simulated virtual layout to the image management device 200. However, in other embodiments provided in the disclosure, the electronic device 100 can also perform some functions of the image management device 200 (e.g., store images, divide images, set the layout, and so on) or even be integrated to the image management device 200. Namely, the image management device 200 may be a functional unit (capable of processing and managing images), regardless of whether it is independent from or integrated into the electronic device 100 and whether it is hardware or software. As such, even though there is any change to the number of displays on the display wall 300 and the actual layout, the settings in the image management device 200 can be easily updated through the capturing operation performed by the electronic device 100. For instance, the electronic device 100 may be a digital camera having an image capturing lens, a smart phone having the same, a tablet PC having the same, a handheld game console having the same, and so on, which should not be construed as a limitation in the disclosure.

FIG. 2 is a block view of an electronic device according to an embodiment of the disclosure.

With reference to FIG. 2, the electronic device 100 provided in the embodiment includes an image capturing element 101, a communication module 103, and a processor 105, wherein the image capturing element 101 and the communication module 103 are electrically coupled to the processor 105.

The image capturing element 101 is configured to obtain an image. For instance, the image capturing element 101 can be built in or externally connected to the body of the electronic device 100 and equipped with a charge coupled device (CCD), a complementary metal-oxide semiconductor (CMOS) device, or an image capturing lens of another type of photosensitive device, which should not be construed as a limitation in the disclosure. In the embodiment, the image capturing element 101 can be configured to capture a display wall image of the display wall 300.

The communication module 103 is configured to receive signals and data. For instance, the communication module 103 may include a cabled module, such as an Ethernet module, an HDMI module, and a USB module, or a wireless module, such as a 3G module, a 4G module, a Bluetooth module, a wireless fidelity (Wi-Fi) module, a LoRa module, an SIGFOX module, an NB-IoT module, or a combination of the aforesaid modules and modules adopting other communication technologies, which should however not be construed as a limitation in the disclosure. In the embodiment, the communication module 103 can electrically communicate with the image management device 200 and the displays 310-1 to 310-6 of the display wall 300 through any of the above-mentioned cabled or wireless modules and is configured to transmit data with the display 310-1 to 310-6 and the image management device 200.

The processor 105 is responsible of performing the layout identification method of the display wall 300. For instance, the processor 105 may be a dual-core, quad-core, octa-core, or any other type of central processing unit (CPU), a system-on-chip (SOC), an application processor, a media processor, a microprocessor, a digital signal processor, a programmable controller, an application specific integrated circuit (ASIC), a programmable logic device (PLD), any other similar device, or a combination of the above. The type of the processor practically implemented in the real world is not limited in the disclosure. In the embodiment, the processor 105 executes display wall layout identification software provided by the electronic device 100 and accordingly performs steps of the layout identification method. The detailed steps of the layout identification method will be described in the following paragraphs.

For accurate identification, the electronic device 100 provided in the embodiment further includes an accelerometer 107 and a gyroscope 109 both electrically coupled to the processor 105. In some embodiments, the electronic device 100 may not include any accelerometer 107 nor any gyroscope 109. People having ordinary skill in the pertinent field can learn the structures and the way to operate the accelerometer 107 and the gyroscope 109 according to relevant published technical documentation, and therefore no further explanation will be given hereinafter.

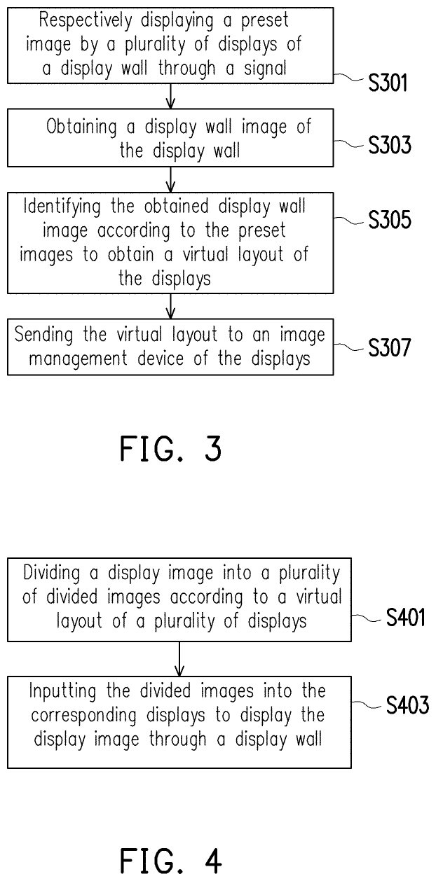

FIG. 3 is a flow chart of a layout identification method according to an embodiment of the disclosure; FIG. 4 is a flow chart of a display method according to an embodiment of the disclosure.

The layout identification method and the display method provided in the embodiment are adapted to the display system and the electronic device 100 described in the embodiments depicted in FIG. 1 and FIG. 2, and therefore the explanation below will be given with reference to the display system and the electronic device 100 described in the embodiments depicted in FIG. 1 and FIG. 2. It should be mentioned that the layout identification method provided in the embodiment is not limited to be performed through the display system and the electronic device 100 described in the embodiments depicted in FIG. 1 and FIG. 2.

With reference to FIG. 3, the electronic device 100 has the displays 310-1 to 310-6 of the display wall 300 respectively display a preset image through a signal (step S301). For instance, the processor 105 executes layout identification software, and a user is able to use buttons provided on a user interface of the software, so that the electronic device 100 issues signals that require displays 310-1 to 310-6 to respectively display the preset images. In an embodiment, the preset images are stored in the memory (not shown) of the electronic device 100; after the processor 105 receives the signals, the processor 105 respectively transmits the preset images to the displays 310-1 to 310-6 through the communication module 103. After the displays 310-1 to 310-6 receive the signal, the displays 310-1 to 310-6 respectively display the preset images.

According to some embodiments, the preset images are stored in the memory (not shown) of each of the displays 310-1 to 310-6 in advance, for instance, and the processor 105 respectively transmits a trigger signal to each of the displays 310-1 to 310-6 through the communication module 103. After the displays 310-1 to 310-6 receive the trigger signals, the displays 310-1 to 310-6 respectively display the preset images.

In some embodiments, the preset images are stored in the image management device 200 in advance, for instance, and the processor 105 transmits a trigger signal to the image management device 200 through the communication module 103. After the image management device 200 receives the trigger signal, the image management device 200 inputs the preset image respectively into each of the displays 310-1 to 310-6, so as to have each of the displays 310-1 to 310-6 respectively displays the preset image.

In some embodiments, the processor 105 directly transmits an image signal including the preset image to each of the displays 310-1 to 310-6 through the communication module 103 or transmits the image signal to the image management device 200, for instance, and the image management device 200 inputs the preset image to each of the displays 310-1 to 310-6, so as to have each of the displays 310-1 to 310-6 respectively display the preset image. As such, the electronic device 100 can determine the content of the preset image.

In order to identify the display range of each of the displays 310-1 to 310-6 in subsequent steps, note that the displays 310-1 to 310-6 display the preset images in a full-screen manner. More particularly, even though the length-to-width ratio of each of the displays 310-1 to 310-6 is different, the length or width of the preset image is proportionally scaled up or down while the preset image is being displayed, so that the display range of each of the displays 310-1 to 310-6 is filled with the preset image. In order to identify the display range of each of the displays 310-1 to 310-6 in subsequent steps, note that the displays 310-1 to 310-6 display the preset images in a full-screen manner.

The electronic device 100 then obtains a display wall image of the display wall 300 (step S303). For instance, after each of the displays 310-1 to 310-6 displays the preset image, the user is able to capture the image of the display wall 300 by using the image capturing element 101 of the electronic device 100, so as to obtain the display wall image of display wall 300 including all of the displays 310-1 to 310-6 thereon.

According to some embodiments, the user is able to hold the electronic device 100 at any position or angle and capture the image, and therefore the relative angle between the lens of the image capturing element 110 during the image capturing action and the wall surface of the display wall 300 can vary. While the electronic device 100 obtains the display wall image of the display wall 300 by using the image capturing element 101, the electronic device 100 also obtains accelerometer data by using the accelerometer 107 and obtains gyroscope data by using the gyroscope 109. As such, in the subsequent steps, the virtual layout of the displays 310-1 to 310-6 can be accurately calculated according to the captured display wall image.

According to the preset images, the electronic device 100 then identifies the obtained display wall image, so as to obtain the virtual layout of the displays 310-1 to 310-6 (step S305). Particularly, the display wall image includes the displays 310-1 to 310-6 displaying the preset pattern in a full-screen manner; therefore, given that the preset pattern is known, the electronic device 100 can identify the location of the display range of the displays 310-1 to 310-6 according to the preset pattern in the display wall image and identify which display range belongs to each display according to display identification numbers in the display wall image, so as to obtain the virtual layout of the displays 310-1 to 310-6.

In some embodiments, the processor 105 calibrates the crooked display wall image according to the accelerometer data and the gyroscope data and calculates the virtual layout of the displays 310-1 to 310-6 according to the preset images.

The electronic device 100 then sends the calculated virtual layout to the image management device 200 of the displays 310-1 to 310-6 (step S308).

In some embodiments, the virtual layout is, for instance, displayed in form of the data structure [“display identification number”, “location of the display range”] and transmitted to the image management device 200, wherein the “location of the display range” includes coordinates of the upper-left corner and upper-right corner of the display range, for instance, which should however not be construed as a limitation in the disclosure.

With reference to FIG. 4, the image management device 200 divides the display image into a plurality of divided images according to the virtual layout of the displays 310-1 to 310-6 (step S401). Specifically, after the electronic device 100 receives the virtual layout of the displays 310-1 to 310-6, the image management device 200 configures the settings according to the virtual layout. When the image management device 200 has the demand for displaying the display image by using the display wall 300, the image management device 200 divides the display image into a plurality of divided images according to the set virtual layout, wherein each of the divided images corresponds to one of the displays 310-1 to 310-6. For instance, according to the location of the display range of each of the displays 310-1 to 310-6, the image management device 200 divides the display image into a first divided image corresponding to the display 310-1, a second divided image corresponding to the display 310-2, a third divided image corresponding to the display 310-3, a fourth divided image corresponding to the display 310-4, a fifth divided image corresponding to the display 310-5, and a sixth divided image corresponding to the display 310-6.

Next, the image management device 200 respectively inputs the divided images into the corresponding displays, so as to display the complete display image through the display wall 300 (step S403). For instance, the image management device 200 inputs the first divided image into the corresponding display 310-1, inputs the second divided image into the corresponding display 310-2, inputs the third divided image into the corresponding display 310-3, inputs the fourth divided image into the corresponding display 310-4, inputs the fifth divided image into the corresponding display 310-5, and inputs the sixth divided image into the corresponding display 310-6. As such, the displays 310-1 to 310-6 can respectively display the first divided image, the second divided image, the third divided image, the fourth divided image, the fifth divided image, and the sixth divided image; namely, the display wall 300 can display the complete display image by stitching the divided images.

The layout identification method and the display method provided in one or more embodiments of the disclosure are elaborated below with reference to the drawings.

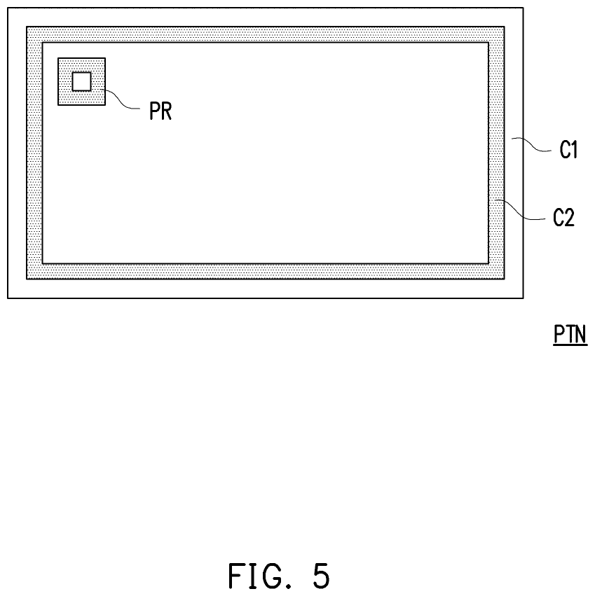

FIG. 5 is a schematic view of a preset pattern according to an embodiment of the disclosure.

With reference to FIG. 5, the preset pattern PTN includes a first color edge C1 and a second color frame C2 of different colors, for instance, and a position recognition pattern PR is located at a predetermined position inside the second color frame C2, wherein the dimension scale of each part of the preset pattern PTN is known and is not limited in the disclosure.

What is more, in some embodiments, the first color edge C1 is configured to differentiate the side frame of the displays from the second color frame C2, so as to prevent misidentification of the range of the second color frame C2 during the image identification (e.g., when the color of the second color frame C2 is identical or similar to the color of the side frame of the displays). Accordingly, the color of the first color edge C1 is preferably designed to be apparently different from the color of the second color frame C2. For instance, when the second color frame C2 is black, the first color edge C1 can be designed to be white. In another aspect, the position recognition pattern PR is configured to make sure the orientation of the displays, and therefore it is better not to arrange the position recognition pattern PR at the center of the second color frame C2 nor to arrange the position recognition pattern PR on a horizontal bisection line or vertical bisection line of the second color frame C2. In the embodiment, the position recognition pattern PR is constantly arranged at the upper-left corner. As such, the processor 105 can derive the location and the orientation of the displays from identifying the location and the angle of the position recognition pattern PR.

In the embodiment, the position recognition pattern PR is designed to be a rectangular frame surrounding a white square, which should however not be construed as a limitation in the disclosure. According to other embodiments, the position recognition pattern PR can be designed as any other pattern recognizable through image identification, e.g., a QR code or the like. In the embodiment, note that the preset pattern PTN serves as an exemplary preset pattern in the preset image but should not be construed as a limitation in the disclosure. People having ordinary skill in the pertinent art can design the preset pattern according to actual requirements.

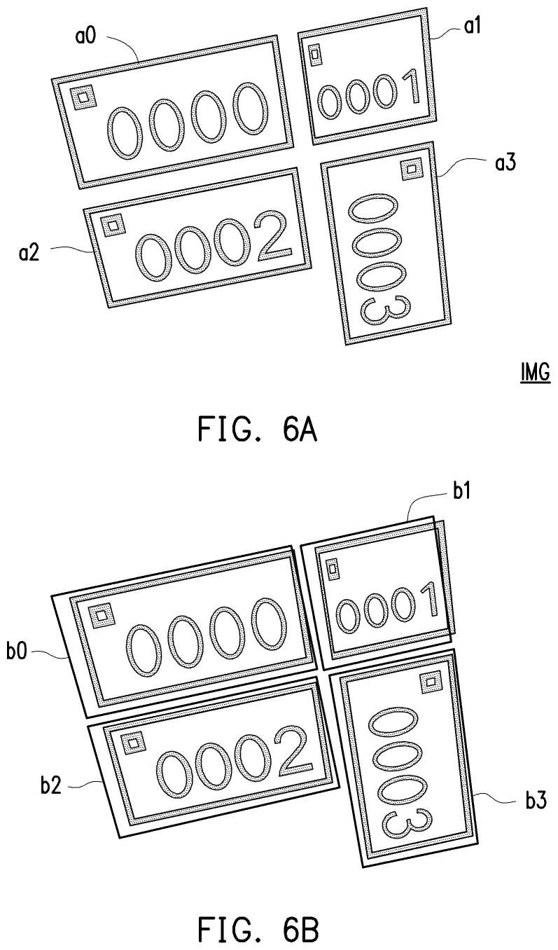

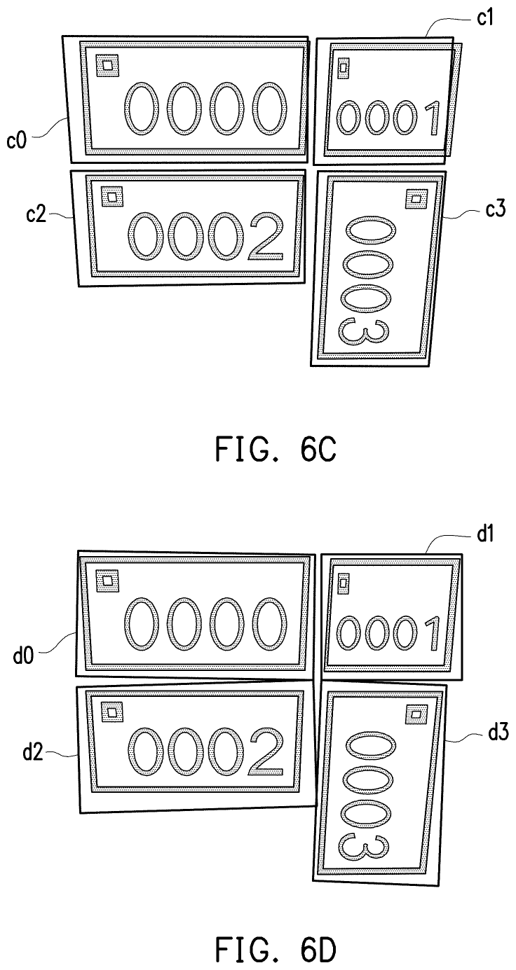

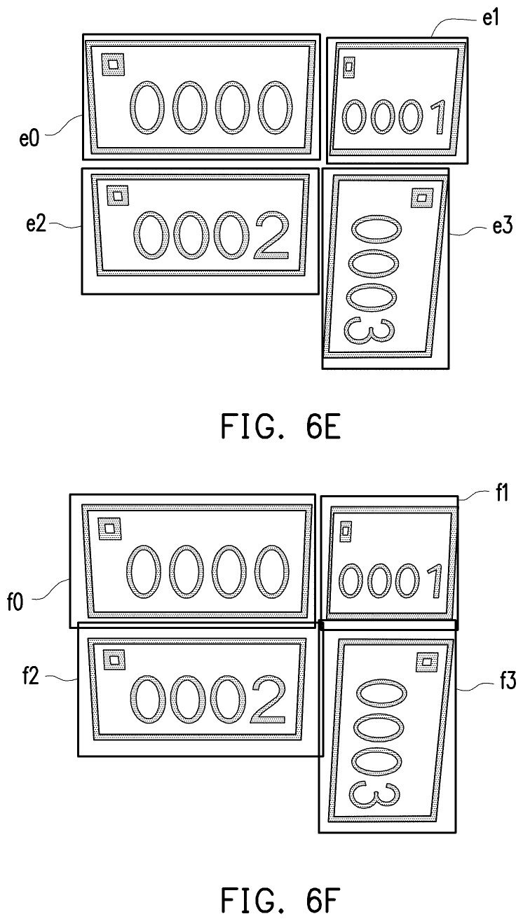

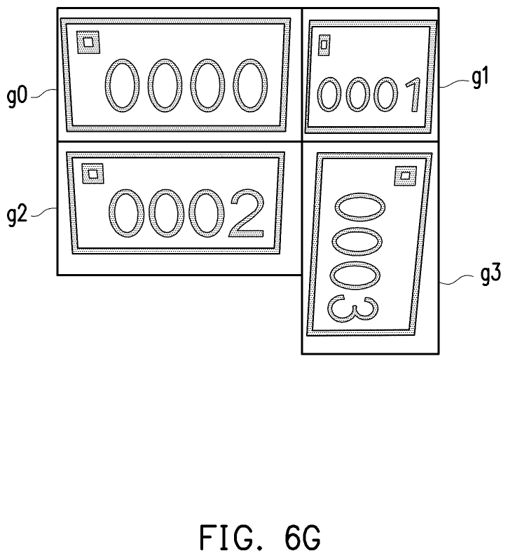

FIG. 6A to FIG. 6G schematically illustrate image identification according to an embodiment of the disclosure. In the embodiment, the actual shape of the displays is assumed to be rectangular, and the following steps are performed for image identification. It should be mentioned that the shape of the displays on the display wall is not limited in the disclosure, and people having ordinary skill in the pertinent art can adjust the algorithm for the image identification without departing from the scope or spirit of the disclosure according to the actual requirements.

As shown in FIG. 6A, after the displays respectively display the preset images in the full-screen manner (e.g., including the display identification numbers and the preset patterns PTN), the image capturing element 101 can capture the display wall image IMG. From the display wall image IMG, it can be learned that the display wall 300 provided in the embodiment includes three rectangular displays with the display identification numbers 0000, 0002, and 0003 and one square display with the display identification number 0001. The display with the display identification number 0000 displays a preset image a0, the display with the display identification number 0001 displays a preset image a1, the display with the display identification number 0002 displays a preset image a2, and the display with the display identification number 0003 displays a preset image a3.

As shown in FIG. 6B, the processor 105 executes an image identification program to find out the contour of the preset pattern from the display wall image IMG. For instance, the processor 105 adopts the OpenCV findContour function or the like to find out the contour of the second color frame C2 and approximates each profile to a quadrilateral by adopting the OpenCV approxPolyDP function or the like. The processor 105 then enlarges each approximated quadrilateral to be corresponding to the first color edge C1 according to the dimension scale of each part of the preset pattern PTN. More specifically, if the preset pattern PTN is a rectangle with the length-to-width ratio of 1920*1080, a length ratio of the preset pattern PTN, the first color edge C1, and the second color frame C2 is 1920:60:60, and a width ratio is 1080:60:60, then the processor 105 elongates two long sides of each approximated quadrilateral up to 1920/1800 times the original length and elongates two short sides of each approximated quadrilateral up to 1080/960 times the original length. As such, fourth outer frames b0 to b3 can be obtained.

As shown in FIG. 6C, the processor 105 rotates outer frames b0 to b3 according to the accelerometer data and the gyroscope data of the electronic device 100 obtained while the display wall image IMG is being taken, so as to comply with the preset standard. For instance, if the normal vector of the screen surface of the electronic device 100 is parallel to the Z axis, the direction of the short side of the screen is parallel to the X axis, and the direction of the long side of the screen is parallel to the Y axis, then the X axis can be set as being parallel to the ground, which is the assumed preset standard. According to the accelerometer data and the gyroscope data, these settings allow the processor 105 to determine that the electronic device 100 should be rotated by a specific angle along the Z axis, for instance, so that the X axis can be parallel to the ground, and the outer frames b0 to b3 are then rotated by said specific angle in a reverse direction. As such, fourth outer frames c0 to c3 can be obtained.

As shown in FIG. 6D, subject to the image-capturing angle, the image identification program, and so on, the four outer frames c0 to c3 are quadrilateral but may not be rectangular. Hence, the processor 105 can, for instance, find out four smallest rectangular outer frames d0 to d3 respectively surrounding the four outer frames c0 to c3 by adopting the OpenCV minAreaRect function or the like.

In the embodiment, it is assumed that no small included angle is left on purpose between every two of the displays of the display wall 300. Hence, as shown in FIG. 6E, the processor 105 performs angle calibration on all rectangular outer frames d0 to d3. For instance, when an angle between long sides and short sides of any two of the rectangular outer frames d0 to d3 is smaller than a preset threshold angle, the processor 105 rotates the two rectangular outer frames to be at an identical angle. Thereby, four rectangular outer frames e0 to e3 that have undergone the angle calibration can be obtained.

In the embodiment, it is assumed that the display wall 300 does not contain any two displays with similar but different dimensions (e.g., a 40-inch display and a 41-inch display). Therefore, as shown in FIG. 6F, the processor 105 performs dimension calibration on rectangular outer frames e0 to e3. For instance, when a length difference between any two long sides of any two of the rectangular outer frames e0 to e3 is less than a preset first threshold length difference, and a length difference between any two short sides of any two of the rectangular outer frames e0 to e3 is less than a preset second threshold length difference, the processor 105 adjusts the two rectangular outer frames to be of an identical dimension. Thereby, four rectangular outer frames f0 to f3 that have undergone the dimension calibration can be obtained.

In some embodiments, the layout identification software executed by the processor 105 provides a display selection interface, which allows the user to input the information (e.g., model number, dimensions, and so on) of all displays on the display wall 300 (or these information has been pre-stored), and the displays are linked to the display identification numbers, respectively. According to the information of the displays, the processor 105 can perform accurate dimension calibration on the rectangular outer frames e0 to e3, so as to obtain four rectangular outer frames f0 to f3.

After the dimension calibration is performed, the four rectangular outer frames f0 to f3 may be overlapped. Hence, as shown in FIG. 6G, the processor 105 aligns the fourth rectangular outer frames f0 to f3. For instance, if a distance between any two vertices of any two of the rectangular outer frames f0 to f3 is overly small, the processor 105 adjusts the two vertices to be at the same location. For instance, the distance between the upper-right vertex of the outer frame f0 and the upper-left vertex of the outer frame fl is smaller than the preset threshold distance, and the distance between the lower-right vertex of the outer frame f0 and the lower-left vertex of the outer frame fl is smaller than the preset threshold distance. Therefore, the processor 105 aligns the outer frame f0 and the outer frame fl, so that the right short side of the outer frame f0 and the left short side of the outer frame fl are overlapped; the rest can be deduced therefrom, so as to obtained the aligned outer frames g0 to g3.

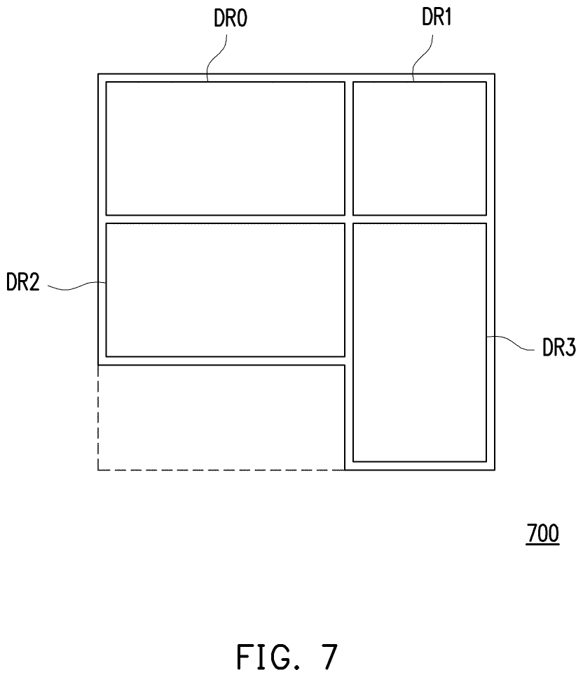

FIG. 7 is a schematic view of a virtual layout according to an embodiment of the disclosure.

With reference to FIG. 7, according to the outer frames g0 to g3, the processor 105 can obtain the virtual layout 700 of the four displays on the display wall 300 and the corresponding actual layout of the display wall 300. In the embodiment, the virtual layout 700 includes a display range DR0 of the upper-left display with the display identification number 0000, a display range DR1 of the upper-right display with the display identification number 0001, a display range DR2 of the lower-left display with the display identification number 0002, and a display range DR3 of the lower-right display with the display identification number 0003.

What is more, the virtual layout 700 is, for instance, displayed in form of the data structure ((display identification number, location of the display range), and the location of the display range may be represented by a coordinate of the upper-left corner and lower-right corner of the display range. In the embodiment, the processor 105 determines the upper-left corner and lower-right corner of the display range according to the location of the position recognition pattern PR.

As illustrated in FIG. 7, according to the position recognition pattern PR in the outer frames g0 to g3, in the virtual layout 700, the upper-left corner of the display range DR0 of the display with the display identification number 0000 is the corner on the upper-left side of the display range DR0 in FIG. 7, but the upper-left corner of the display range DR3 of the display with the display identification number 0003 refers to the corner on the upper-right side of the display range DR3 in FIG. 7.

According to some embodiments, the electronic device 100 transmits the virtual layout 700 to the image management device 200 of the four displays, for instance, and the image management device 200 can set the parameters required for displaying the images in the future according to the virtual layout 700.

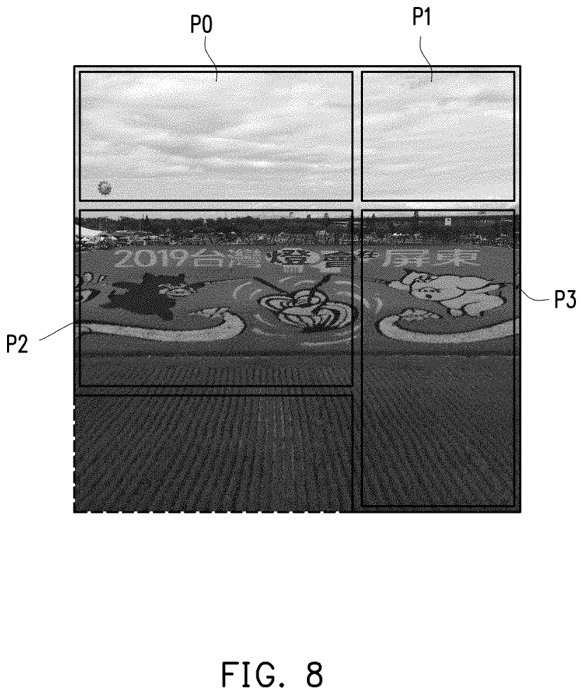

FIG. 8 is a schematic view of a display image according to an embodiment of the disclosure.

With reference to FIG. 8, when there is a demand for displaying a display image on the display wall 300, the image management device 200 divides the display image into a plurality of divided images P0 to P3 according to the virtual layout 700, wherein the divided image P0 on the upper-left corner corresponds to the upper-left display with the display identification number 0000, the divided image P1 on the upper-right corner corresponds to the upper-right display with the display identification number 0001, the divided image P2 on the lower-left corner corresponds to the lower-left display with the display identification number 0002, and the divided image P3 on the lower-right corner corresponds to the lower-right display with the display identification number 0003. The image management device 200 then respectively inputs the divided images P0 to P3 into the corresponding displays. Thereby, as shown in FIG. 8, the four displays on the display wall 300 can respectively display the corresponding divided images P0 to P3, so as to stitch the divided images P0 to P3 and display the complete display image.

To sum up, in the layout identification method of the display wall and the electronic device and the display system using said method according to one or more embodiments of the disclosure, after the electronic device capable of taking pictures and doing calculations is applied to obtain the display wall image, the display wall image is identified to obtain the virtual layout of the displays on the display wall, and the virtual layout is then provided to the image management device of the displays. As such, no matter how the actual arrangement of the displays on the display wall is changed, the virtual layout of the simulated display wall can be generated with ease in an accurate and rapid manner, so as to allow the displays on the display wall to correspondingly display the image according to the virtual layout.

Although the disclosure has been disclosed by the above embodiments, the embodiments are not intended to limit the disclosure. It will be apparent to those skilled in the art that various modifications and variations can be made to the structure of the disclosure without departing from the scope or spirit of the disclosure. Therefore, the protecting range of the disclosure falls in the appended claims.

1. A layout identification method of a display wall applicable to an electronic device, wherein the display wall is formed by stitching a plurality of displays to establish an actual layout according to a preset layout, and the layout identification method comprises:
displaying a preset image through a signal respectively by the plurality of displays of the display wall;
capturing an image of the actual layout of the display wall by an image capturing element to obtain a display wall image of the display wall; and
identifying the display wall image according to an image analysis on the preset images to obtain a virtual layout of the plurality of displays corresponding to the actual layout by identifying a location of a display range and a display identification number of each of the plurality of the displays.

2. The layout identification method according to claim 1, wherein the step of displaying the preset image through the signal respectively by the plurality of displays of the display wall comprises:
transmitting the preset images to the plurality of displays by the electronic device to respectively display the preset image by each of the plurality of displays.

3. The layout identification method according to claim 1, wherein the step of displaying the preset image through the signal respectively by the plurality of displays of the display wall comprises:
respectively transmitting a trigger signal to the plurality of displays to respectively display the preset image by each of the plurality of displays, wherein the preset images are pre-stored in the plurality of displays.

4. The layout identification method according to claim 1, wherein the step of displaying the preset image through the signal respectively by the plurality of displays of the display wall comprises:
transmitting a trigger signal to an image management device to respectively input the preset images to the plurality of displays by the image management device.

5. The layout identification method according to claim 1, after the step of identifying the display wall image according to the image analysis on the preset images to obtain the virtual layout of the plurality of displays corresponding to the actual layout, the method further comprising:
dividing a display image into a plurality of divided images according to the virtual layout by an image management device; and
respectively transmitting the plurality of divided images to the plurality of displays correspondingly to display each of the plurality of divided images by corresponding display accordingly.

6. The layout identification method according to claim 1, wherein the step of obtaining the display image wall of the display wall comprises:
when obtaining the display wall image, obtaining accelerometer data and gyroscope data of the electronic device, wherein the step of identifying the display wall image according to the image analysis on the preset images to obtain the virtual layout of the plurality of displays corresponding to the actual layout comprises:
determining the virtual layout of the plurality of displays according to the preset image, the accelerometer data, and the gyroscope data.

7. The layout identification method according to claim 1, wherein the preset image comprises a preset pattern and the display identification number.

8. (canceled)

9. The layout identification method according to claim 7, wherein the preset pattern comprises a first color edge and a second color frame in different colors, and the first color edge surrounds the second color frame.

10. The layout identification method according to claim 9, wherein the preset pattern further comprises a position recognition pattern located at a predetermined position not at a center of the second color frame.

11. The layout identification method according to claim 9, wherein the first color edge is expanded from the second color frame in an outward manner according to a predetermined relationship and correspondingly defines a quadrilateral outer frame.

12. The layout identification method according to claim 11, wherein the image analysis comprises:
defining a minimum rectangular outer frame surrounding the quadrilateral outer frame for the quadrilateral outer frame.

13. The layout identification method according to claim 12, wherein the image analysis comprises:
performing angle calibration on each rectangular outer frame;
wherein when an angle between long sides and short sides of any two of the rectangular outer frames is smaller than a preset threshold angle, the two rectangular outer frames are rotated to be at an identical angle.

14. The layout identification method according to claim 12, wherein the image analysis comprises:
performing dimension calibration on each rectangular outer frame;
wherein when a length difference between long sides of any two of the rectangular outer frames is less than a preset first threshold length difference, adjusting the two rectangular outer frames to be of an identical dimension.

15. The layout identification method according to claim 12, wherein the image analysis comprises:
performing dimension calibration on each rectangular outer frame;
wherein the dimension calibration is performed on each rectangular outer frame according to dimension information of each of the plurality of displays.

16. The layout identification method according to claim 12, wherein the image analysis comprises:
aligning each rectangular outer frame,
wherein when a distance between any two s of any two of the rectangular outer frames is shorter than a preset threshold distance, adjusting the two vertices to one location to perform alignment.

17. The layout identification method according to claim 1, wherein the step of displaying the preset image through the signal respectively by the plurality of displays of the display wall comprises:
respectively displaying the preset images in a full-screen manner by the plurality of displays through the signal.

18. An electronic device capable of being configured to be used together with a display wall, wherein the display wall is formed by stitching a plurality of displays to establish an actual layout according to a preset layout, and the electronic device comprises:
a communication module configured to electrically communicate with the plurality of displays of the display wall;
an image capturing element configured to capture an image of the actual layout of the display wall to obtain a display wall image of the display wall;
a processor electrically coupled to the communication module and the image capturing element and configured to:
instruct the plurality of displays respectively to display a preset image through the communication module; and
identify the display wall image according to an image analysis on the preset images to obtain a virtual layout of the plurality of displays corresponding to the actual layout by identifying a location of a display range and a display identification number of each of the plurality of the displays.

19. The electronic device according to claim 18, further comprising:
an image management device configured to divide a display image into a plurality of divided images according to the virtual layout and transmit the plurality of divided images to the plurality of displays corresponding to the plurality of divided images through the communication module.

20. The electronic device according to claim 18, further comprising an accelerometer and a gyroscope, wherein when the processor obtains the display wall image, the accelerometer obtains accelerometer data, the gyroscope obtains gyroscope data, and the virtual layout of the plurality of displays is calculated by the processor according to the image analysis on the preset images, the accelerometer data, and the gyroscope data.

21. The electronic device according to claim 18, wherein the preset image comprises a preset pattern and the display identification number.

22. The electronic device according to claim 21, wherein the preset pattern comprises a first color edge and a second color frame in different colors, and the first color edge surrounds the second color frame.

23. The electronic device according to claim 22, wherein the preset pattern further comprises a position recognition pattern located at a predetermined position not at a center of the second color frame.
